(19) United States
(12) Patent Application Publication
(10) Pub. No.: US 2011/0260449 A1
(43) Pub. Date: Oct. 27, 2011

(54) APICAL ACCESS AND CONTROL DEVICES

(76) Inventor: James L. Pokorney, Northfield, MN (US)

(21) Appl. No.: 13/091,630

(22) Filed: Apr. 21, 2011

Related U.S. Application Data
(60) Provisional application No. 61/326,451, filed on Apr. 21, 2010.

(51) Int. Cl. F16L 39/00

(52) U.S. Cl. 285/321

(57) ABSTRACT

An access and control device consists of a safety ring, a connector, and a separator ring. The safety ring has loops on its proximal surface. The connector has a cuff around its periphery with hooks on its distal surface. The separator ring is positioned between safety ring and cuff to not allow hooks to engage with loops. When the separator ring is removed, the hooks engage with the loops to form a connection between the safety ring and the connector/cuff assembly.

### CROSS REFERENCE TO RELATED APPLICATION

This application claims priority from U.S. provisional application Ser. No. 61/326,451 filed on Apr. 21, 2010, which is hereby incorporated by reference in its entirety.

### FIELD OF THE INVENTION

This invention relates to improved connection devices that allow safe and near bloodless implantation of blood carrying conduits and other devices into a beating heart.

### BACKGROUND OF THE INVENTION

When medical devices, in particular blood carrying conduits, are implanted into the wall of a beating heart, the implantation process is both difficult and dangerous. In particular, the difficulties lie in accessing the left ventricle while the heart is still pumping. To those knowledgeable in the art, it is known there is a high chance for blood loss and tissue tearing during the insertion and attachment process. In the current technique, the surgeon sews the conduit into the heart after it has been installed. In this invention, a safety ring is sewed to the heart before cutting begins. This ring helps to prevent tearing during the cutting process. After the conduit is installed through the heart wall, in current techniques a long suturing process is required to attach the conduit securely to the heart. During this process, there is a chance for substantial blood loss. In this invention, once the conduit is fully inserted and positioned, it is almost instantly attached to the heart using a hook and loop system.

### BRIEF SUMMARY OF THE INVENTION

The primary object of the present invention is to provide a family of implant devices and related surgical methods to safely insert a blood carrying conduit, a Ventricular Assist Device (VAD), or some other device into the apex of a beating heart or some other blood filled passageway.

Specifically, there are three related concepts, one for direct, one-step insertion of a connector and attached conduit into the heart that depends on a cutting tool being inserted through the implantable conduit. The second concept allows for a two step insertion process, allowing for the cutting tool to be used independent of the implantable connector/conduit. The third concept allows for permanently occluding the access hole made during implantation if a temporary connector is inserted and then removed. In all cases, the heart tissue surrounding the insertion site is secured before making the access hole to prevent tearing. There is essentially no blood loss during the procedure. The invention, as represented in one or more embodiments, has many advantages including but not limited to the following:
1. A medical device can be inserted thru the heart wall with little surface friction.
2. After placement into the heart wall, a medical device can be easily rotated before final permanent attachment.
3. After implantation, the medical device can be immediately secured to the heart without suturing or blood loss.
4. By employing a safety ring having a hemostasis aperture and a loop (or hook) surface, a hole can be cut and a cutting tool and tissue plug can be removed without blood loss. Then a Ventricular Assist Device or another medical device can be inserted through the hemostasis aperture and immediately affixed to the heart.
5. During the connection process, very little blood loss occurs.
6. After a temporary medical device is removed from the access hole, a permanent plug can be quickly affixed to the safety ring to provide permanent hemostasis.

The above mentioned objects and advantages of this invention will become apparent from the following description taken in connection with the accompanying drawings, wherein is set forth by way of illustration and example, preferred embodiments of this invention.

### BRIEF DESCRIPTION OF THE DRAWINGS

FIG. 1 shows the design elements in exploded view.

FIG. 2 shows an embodiment of the conduit.

FIG. 3 shows an embodiment of the sheath.

FIG. 4 shows an embodiment of the safety ring.

FIG. 5 shows an embodiment of the safety ring.

FIG. 6 shows an embodiment of the safety ring.

FIG. 7 shows an embodiment of the separator ring.

FIG. 8 shows an embodiment of the separator ring.

FIG. 9 shows an embodiment of an occluder.

FIG. 10 shows an embodiment of a cutting tool.

FIG. 11 shows an embodiment of the invention used in cardiac surgery.

FIG. 12 shows an embodiment of the invention used in cardiac surgery.

FIG. 13 shows an embodiment of the invention used in cardiac surgery.

FIG. 14 shows an embodiment of the invention used in cardiac surgery.

FIG. 15 shows an embodiment of the invention used in cardiac surgery.

FIG. 16 shows an embodiment of the invention used in cardiac surgery.

FIG. 17 shows an embodiment of the invention used in cardiac surgery.

### DETAILED DESCRIPTION OF THE INVENTION

The terms “proximal” and “distal,” when used herein in relation to instruments used in the procedure of the present invention, respectively refer to directions closer to and farther away from the operator performing the procedure.

This invention describes a new set of tools to insert a hollow conduit into a fluid filled organ. In one preferred embodiment, the organ is a left ventricle of a human heart. This invention could be useful in other organs in a human or animal such as the right ventricle, the left or right atrium, the stomach, the bladder, or other fluid filled organs. Generally described, the invention consists of a conduit with a connector on at least one end. The conduit carries fluid into or out of the fluid filled organ. The other end of the conduit could be directly connected to a blood vessel or another fluid filled organ. In some applications, it could be connected to a ventricular assist pump device or to a prosthetic heart valve.

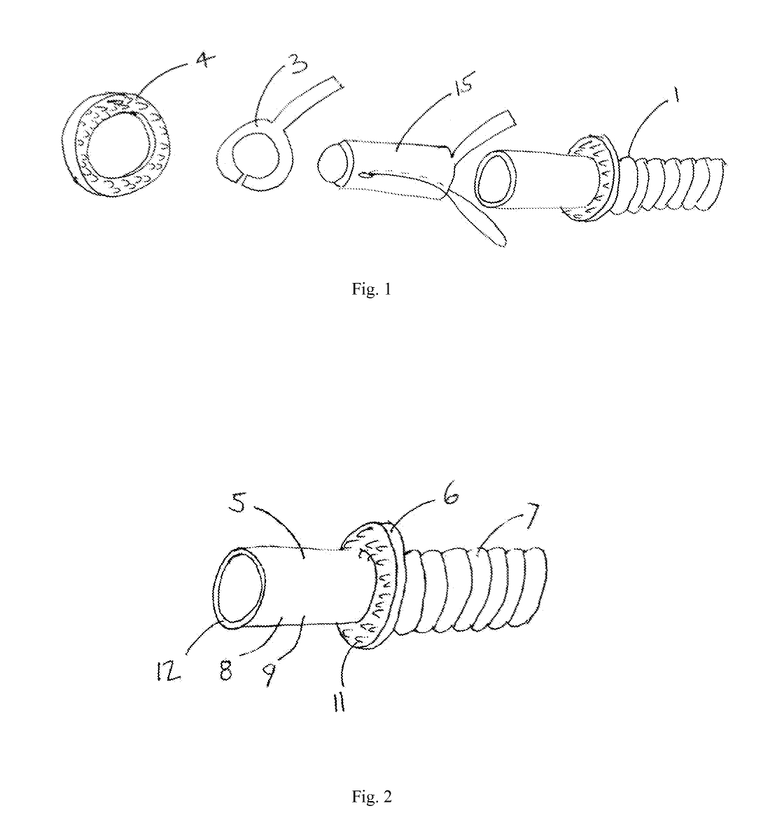

A general description of one embodiment of the invention is shown in FIG. 1. In this sketch are shown the basic components of the invention: a Graft 1, a Protective Sheath 15, a Separator Ring 3, and a Safety Ring 4. A further description of each general component follows.

Graft

As shown in FIG. 2, the implantable Graft 1 is composed of three elements: a Connector 5, a Cuff 6, and a Conduit 7. In one embodiment, the Connector 5 is a cylindrical Tube 8 covered with a Liner 9. The Tube 8 is rigid enough to not collapse when inserted into the heart wall. It is composed of titanium, stainless steel, polycarbonate or some other biocompatible material. The Tube 8 could be bare or could be covered inside and out with a Liner 9. The purpose of the Liner is to provide a good surface for tissue ingrowth (outside surface of Connector) as well as blood flow (inside surface of Connector). The Liner 9 is composed of polyester or some other biocompatible material. The Connector 5 has a Distal Edge 12. The Connector 5 is connected to the Conduit 7 to form a fluid tight pathway. Conduit 7 is composed of knitted or woven polyester or expanded polytetrafluoroethylene (PTFE) or a similar biocompatible material. Near the junction of Connector 5 and Conduit 7 is located Cuff 6. The Cuff 6 is firmly and permanently secured to the Connector and Cuff by using a suture or biocompatible glue, or some other fastening method. The Cuff 6 is disc shaped and composed of polyester, PTFE, or another suitable biocompatible material. On the distal surface of the Cuff 6 are located Hooks 11. These Hooks are firmly attached to the Cuff surface and protrude generally perpendicular to the Cuff surface. In one embodiment, the end of the hook is bent to form an included angle less than about ninety degrees. The hooks populate the distal surface in close proximity to each other much like trees populate a heavy, dense forest. A typical type hook structure would be similar to that made popular by Velcro® fastening systems. There are many variations in hook and loop designs that would work in this invention.

Protective Sheath

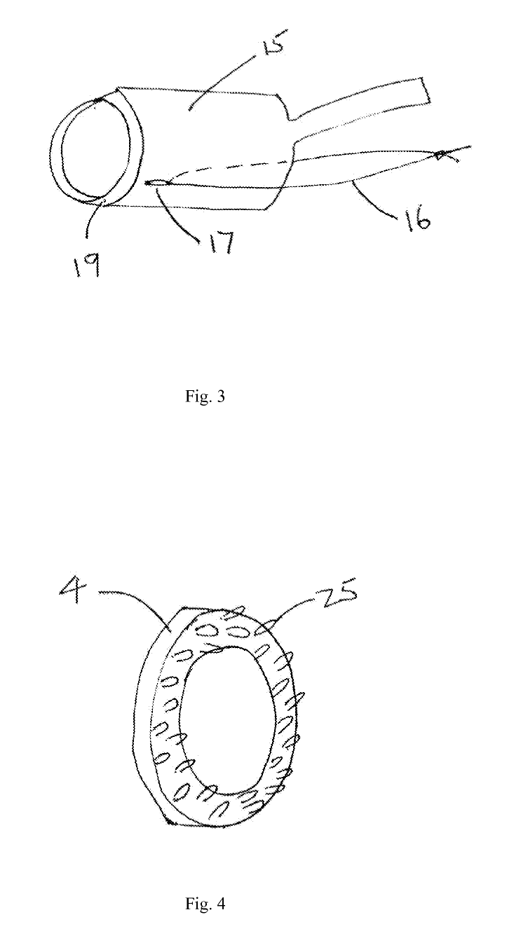

A Sheath 15, as shown in FIG. 3, is used in the invention to isolate the Liner 9 from tissue during insertion. It is important to isolate the Liner from the adjacent tissue during insertion because the Liner typically has a high coefficient of friction making insertion difficult. The generally cylindrically shaped Sheath 15 is composed of a thin, low friction material such as polyethylene and has a thickness of about 0.005″. A Pull String 16 is inserted though Slit 17 located near Distal End 18 of Sheath 15. The Pull String 16 is a polyester thread or some other biocompatible material. The Slit 16 is formed by piercing or cutting the Sheath 15 using a sharp blade or other cutting tool. In this embodiment, the Sheath has a Distal Taper 19 that when assembled covers the Distal Edge 12 of Connector 5. The Sheath also has a Pull Handle 21. Note, the Sheath 15, due to its slippery surface would not be a good long term implant material with regard to permanent attachment or fixation to tissue.

Safety Ring

A Safety Ring 4, as shown in FIG. 4, is a relatively non-distensible fabric ring that can be firmly attached to the heart using sutures. The ring has an inside diameter that is slightly larger than the outside diameter of Connector 5 and an outside diameter about the same dimension as the outside diameter of Cuff 6. On the non-cardiac side of Safety Ring 4 is located a dense series of Loops 25. Loops 25 are composed of polyester or some other biocompatible material and are firmly attached to the Safety Ring surface and protrude generally perpendicular to the surface. The loops populate the distal surface in close proximity to each other much like trees populate a heavy, dense forest. A typical type of loop structure would be similar to that made popular by Velcro® fastening systems.

Safety Ring with Hemostasis Aperture

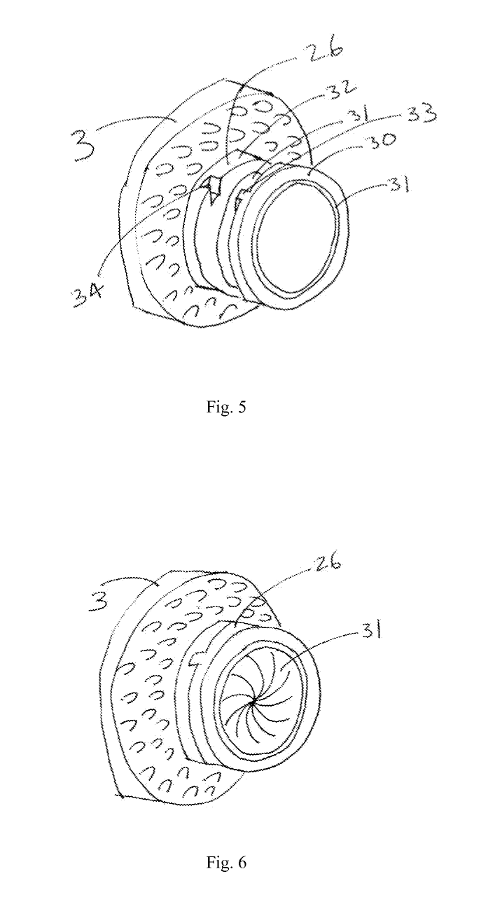

In an alternative embodiment, the safety ring can be fabricated with a hemostasis aperture located over its center opening as shown in FIGS. 5 and 6. The hemostasis aperture allows the user to adjust the size of the internal opening to limit blood flow out of the Safety Ring after the hole is created. The Hemostasis Aperture will prevent blood loss if the hole is left open or unattended. A preferred embodiment of a Hemostasis Aperture 26 is shown open in FIG. 5 and closed in FIG. 6. The Hemostasis Aperture consists of three main elements: Proximal Ring 30, Elastomeric Tube 31, and Distal Ring 32. In this embodiment, the Proximal Ring 30 has a Key 33 located on its distal surface and the Distal Ring 32 has a Keyway 34 located on its proximal surface. The Hemostasis Aperture is affixed to the Safety Ring 3 by sewing, gluing, or some other method. When the Proximal Ring 30 is rotated relative to the Distal Ring 32, the Elastomeric Tube 31 twists upon its central axis and closes shut, thereby minimizing any fluid flow through the device. The user can mate the Proximal Ring 30 with the Distal Ring 32 by inserting the Key 33 into the Keyway 34 to maintain a selected partially closed or fully closed position.

Separator Ring

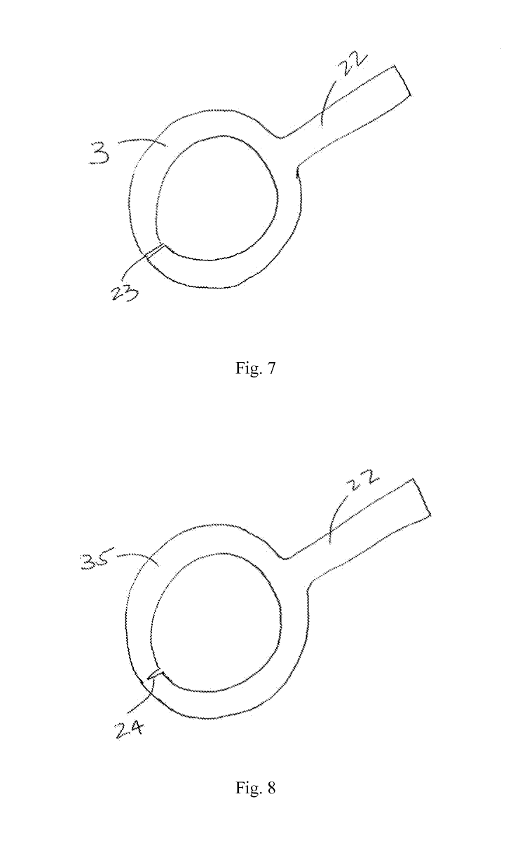

A thin circular Separator Ring 3, as shown in different embodiments in FIG. 7 and FIG. 8 is used to temporarily isolate the Hooks 11 located on the Cuff 6 from the Loops 25 located on Safety Ring 4. The Separator Ring 3 has an inside diameter and outside diameter about the same size as the Safety Ring 4 and Cuff 6. The Separator Ring 3 is generally a thin film about 0.005″ thick and composed of polyethylene, polycarbonate, or some other material that does not attach to either Hooks 11 or Loops 25. The Ring 3 has a Pull Handle 22 to allow the user to grab and control the Ring. Also, the Separator Ring 3 has a Full Cut 23 as shown in FIG. 7 or in a different preferred embodiment as shown in FIG. 8, a Separator Ring 35 has a Semi-Full Cut 24.

Occluder

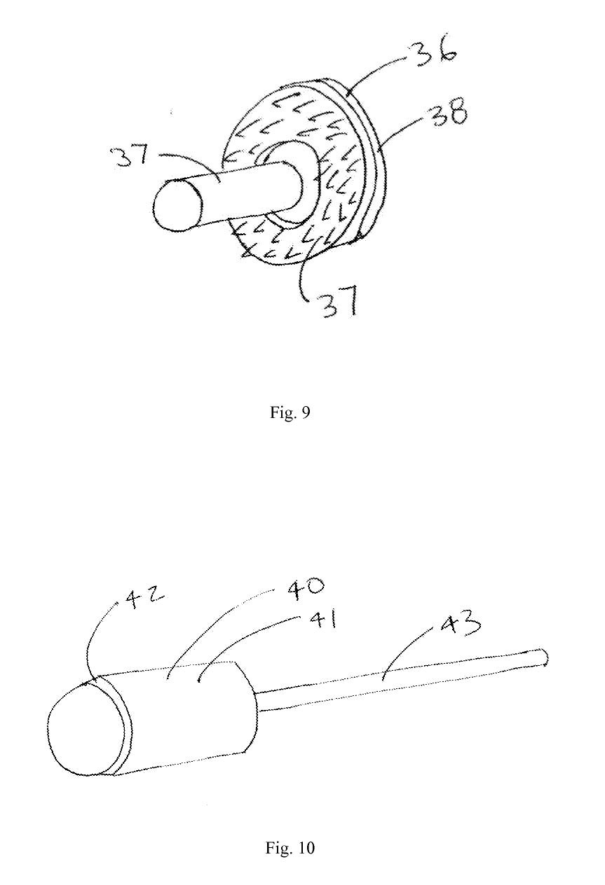

In some cases such as an aborted permanent implant or if a temporary device is used there may be a need to permanently occlude the access hole. In this case, an Occluder Device, as shown in one embodiment in FIG. 9 has been invented. The Occluder 36 has a Plug 37 designed to fit in close contact with the cut hole. The Plug 36 is made of a biocompatible material suitable for long term implant contact with tissue and blood. Material could be polyester, polytetrafluoroethylene, collagen, or other suitable material. The Occluder 36 has a Cover 38 attached to the Plug 37. Its outer diameter is similar to that of the Safety Ring 4. It has a Hook Surface 37 on its distal surface to align and mate with Loops 25 on the proximal surface of Safety Ring 4. In use, the Plug is inserted into the previously cut hole and immediately secured by engaging the Hooks 37 with the Loops 25.

Cutting Tool

For purposes of this invention a simple Cutting Tool 40 is shown in FIG. 10. A more detailed cutting tool is described by the applicant in U.S. patent application Ser. Nos. 10/975,941 and 11/825,187, which are incorporated by reference herein in their entireties. The Cutting Tool 40 is a Cylinder 41 with a sharp Edge 42 on its distal end. The proximal end of the Cutting Tool is bonded to a Shaft 43. The outside dimension of the Cylinder 41 is sized to be easily inserted into the Graft 1 and is sized to be about the same diameter as the inside diameter of Distal Taper 19 located on Sheath 15.

Description of Operation

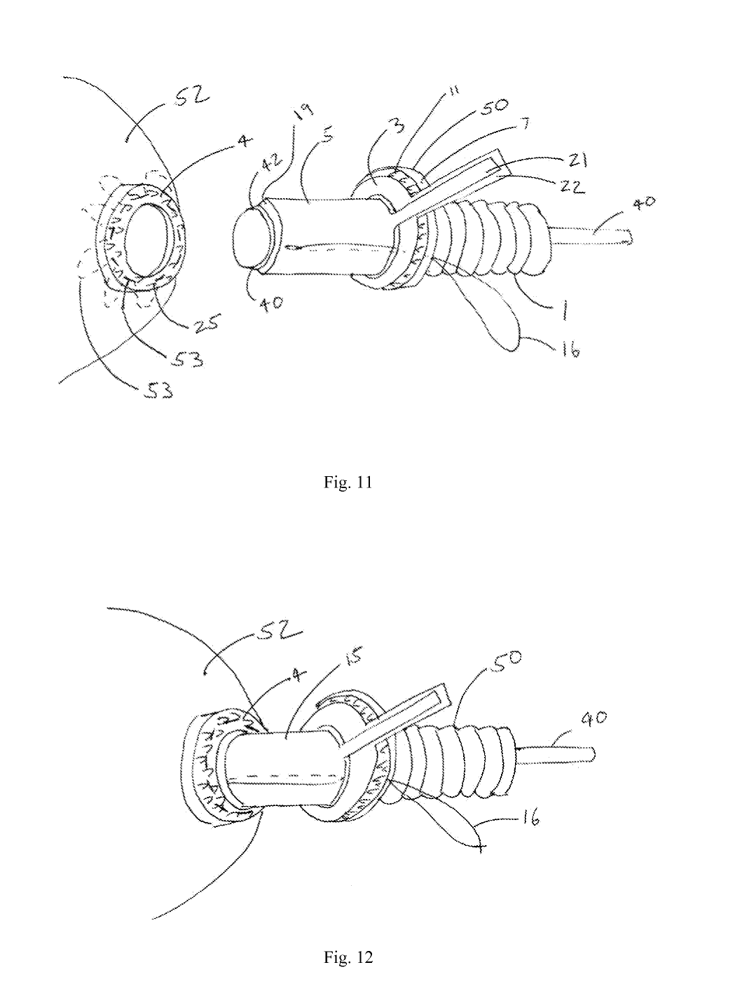

FIG. 11 shows the design elements assembled in a preferred Device 50. The Safety Ring 4 is firmly attached to Heart 52 with Sutures 53. Loops 25 are on the proximal, non-heart surface. The Separator Ring 3 is inserted over the Connector 5 and covers the Hooks 11 attached to Cuff 7. The Sheath 15 is inserted over the Connector 5. The Handle 21 of Sheath 15 aligns with and overlaps Handle 22 of Separator Ring 3. The Cutting Tool 40 is inserted through Graft 1 with sharp Edge 42 extending beyond the Distal Taper 19 of Sheath 15.

As shown in FIG. 12, Device 50 is advanced into Heart 52 through the central opening of the Safety Ring 4. The heart wall tissue is captured within the Cutting Tool 40. As tissue is cut, the Device 50 advances into the heart with little friction due to the low coefficient of friction of Sheath 15. The Device 50 is advanced until the Separator Ring 3 and adjacent Cuff 6 are in close contact with Safety Ring 4. Although in close proximity, the Hooks 11 do not engage with Loops 25. This non-engagement is provided by the Separator Ring 3 and allows the user to rotate Device 50 relative to the Heart 52 before affixing in place.

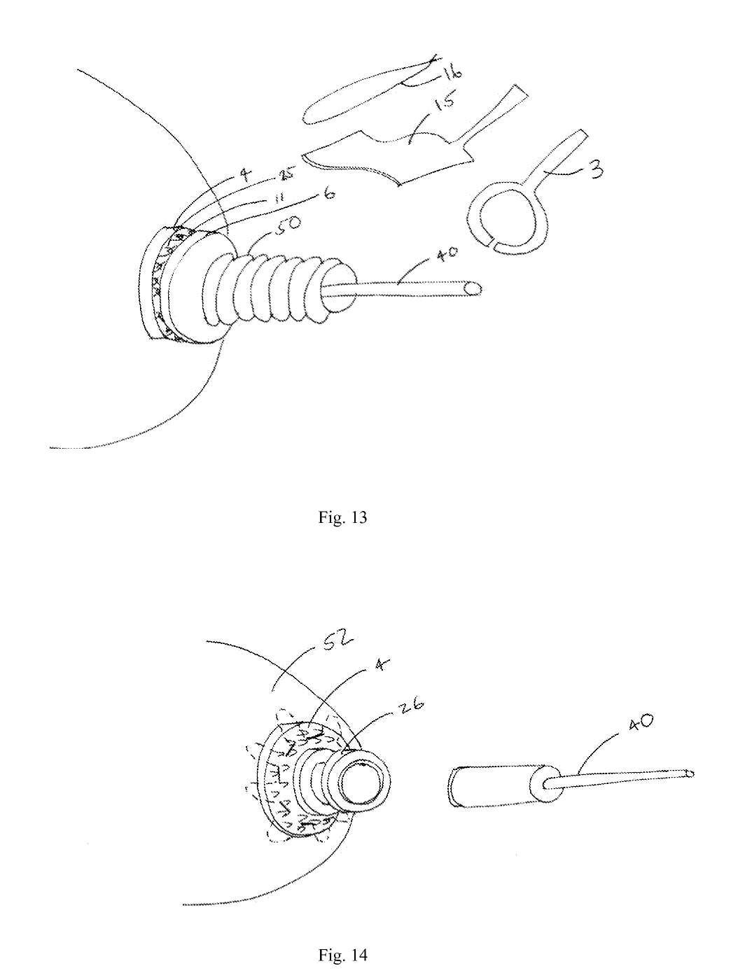

When rotation position is satisfactory, the Sheath 15 and the Separator Ring 3 are removed as shown in FIG. 13. The Sheath is removed in a two part process. First the Pull String 16 is pulled proximally to longitudinally tear the Sheath proximal of Slit 17. Only a small portion of the Sheath distal of the Slit is not torn. After Pull String 16 is removed, the Sheath 15 and the Separator Ring 3 can both be removed in unison. During removal, the remaining portion of Sheath distal of Slit 17 is torn to free the Sheath for removal. Once removed, the user can gently push the Cuff 6 against the Safety Ring 4 to engage the Loops 15 into the Hooks 11 to form a strong attachment. No sutures are necessary.

Operation of Safety Ring with Hemostasis Aperture

In FIG. 14, the Safety Ring 4 is assembled with the Hemostasis Aperture 26. The assembly is attached to the Heart 52. After attachment, a hole is cut into Heart 52 using Cutting Tool 40.

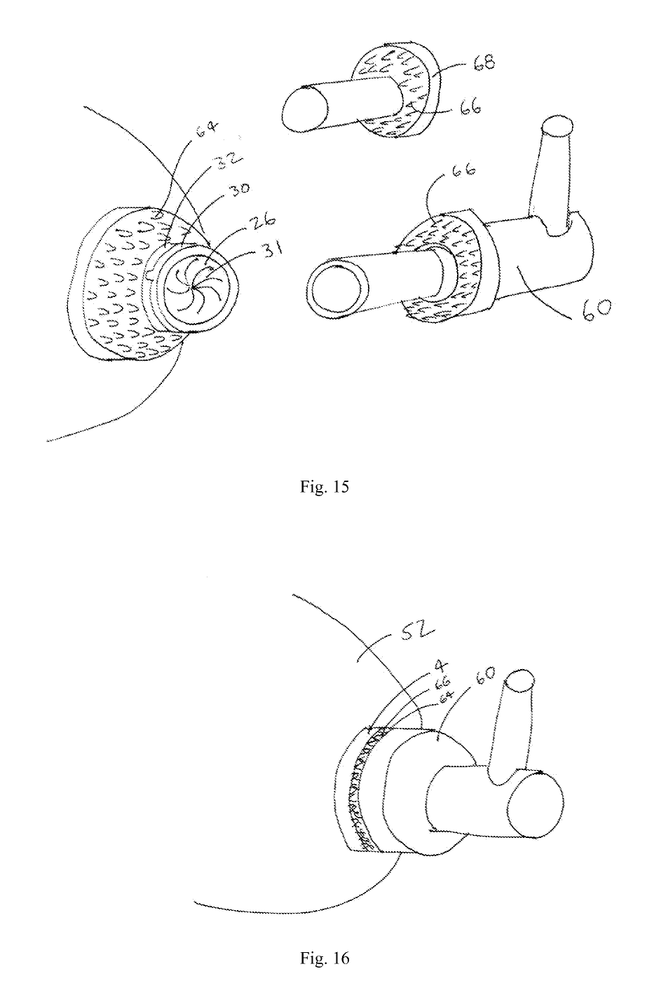

After the hole is cut, the Cutting Tool 40 is removed and the Hemostasis Aperture 26 is quickly twisted until the Elastomeric Tube 31 is closed and locked as shown in FIG. 15. When locked, blood flow is prevented.

At this point, a medical device such as a Ventricular Assist Device (VAD) 60 can be safely inserted into Heart 52 without significant blood loss as shown in FIG. 16. Insertion of VAD 60 into the Heart is accomplished by inserting the VAD through the Safety Ring 4 by opening the Hemostasis Aperture 26 by rotating Proximal Ring 30 to open Elastomeric Tube 31.

When the VAD 60 is completely inserted into the Heart 52, Hooks 66 on Cuff 63 engage with the Loops 64 on Safety Ring 4 to form a strong attachment.

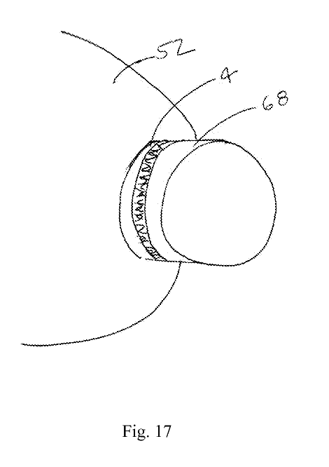

In an alternative embodiment as shown in FIG. 17, Occluder 68 can be inserted into Safety Ring 4 in a similar manner.

It should be noted that in other embodiments the hooks and loops used to form the immediate attachment could be reversed.

What is claimed is:

1. An access and control device comprising:
a) a safety ring, said safety ring having loops on proximal surface;
b) a connector, said connector having a cuff permanently connected to said connector, said cuff having hooks on distal surface; and
c) a separator ring;
wherein when said connector is inserted into said safety ring, the loops on the proximal surface of the safety ring do not engage with the hooks on the distal surface of the cuff because the separator ring is located between them and when the separator ring is removed, the loops on the surface of the safety ring engage with the hooks on the surface of the cuff to form an attachment.

2. An access and control device consisting of a safety ring with aperture control, said device comprising:
a) a safety ring;
b) a distal ring, said stationary ring connected to said safety ring;
c) a proximal ring; and
d) an elastomeric tube connected to said stationary ring and said rotatable ring
and having a relationship such that when the proximal ring is rotated relative to the distal ring, the elastomeric tube twists to form a closed aperture.

3. An apical control and occlusion device comprising:
a) a safety ring; and
b) a plug, said plug having a distal and proximal end and a cover attached to proximal end of said plug and having hooks on its distal facing surface,
and having a relationship such that when said plug is inserted into said safety ring, the loops on the surface of the safety ring engage with the hooks on the surface of the cover to form an attachment.
